(19) United States
(12) Patent Application Publication
(10) Pub. No.: US 2010/0250721 A1
(43) Pub. Date: Sep. 30, 2010

(54) METHOD AND APPARATUS FOR RESERVING FUNCTION OF UPNP DEVICE

(75) Inventor: Young-Chul Sohn, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/161,737

(22) PCT Filed: Jan. 11, 2007
(86) PCT No.: PCT/KR2007/000001

§ 371 Date: Jul. 22, 2008

(30) Foreign Application Priority Data
Jan. 25, 2006 (KR) 10-2006-0007883

(51) Int. Cl. G06F 15/173

(52) U.S. Cl. 709/223

(57) ABSTRACT

A service provided by a universal plug and play (UPnP) device. A control point (CP) discovers the device in a network, controls the device, and reserves the device to perform a specific command at a specific time.

This application is a National Stage of International Application No. PCT/KR2007/000001 and claims the benefit of Korean Patent Application No. 10-2006-0007883, filed on Jan. 25, 2006, in the Korean Intellectual Property Office, the disclosure of which is incorporated herein in its entirety by reference.

### BACKGROUND OF THE INVENTION

1. Field of the Invention

The present invention relates to a universal plug and play (UPnP) device, and more particularly to, a method and apparatus for reserving a function of a UPnP device.

2. Description of the Related Art

Personal computers (PCs) can automatically recognize peripheral devices having a universal plug and play (UPnP) function. Therefore, users can easily install such peripheral devices. UPnP extends such a function to networks to allow networked PCs, peripheral devices, home appliances, etc., to automatically recognize one another. UPnP classifies networked devices as controlled devices (CDs) or devices providing a service, and control points (CPs) controlling the CDs to use the service.

FIG. 1 is a block diagram of a conventional UPnP network system. Referring to FIG. 1, the UPnP networking system comprises a CP 1 and a controlled device 2.

The CP 1 discovers a device on a home network and controls the device according to UPnP. The device 2 is discovered and controlled by the CP 1 in the home network according to UPnP. The device 2 provides functions of the CP1 as a specific service. The service includes a content directory service, a rendering control service, etc. The CP 1 calls actions provided by the service based on a simple object access protocol (SOAP), thereby using the functions of the device 2.

However, the device 2 does not provide a service to reserve functions of the device 2 in the conventional UPnP network system. Therefore, the CP 1 cannot reserve the functions of the device 2. For example, the conventional UPnP network system cannot reserve the device 2 to be powered on/off of or to perform a specific function of the device 2 at a future time. Since a reservation function is indispensable to home appliances such as televisions, audios, washing machines, etc., a service reserving the functions of the device 2 is required.

### SUMMARY OF THE INVENTION

The present invention provides a method and apparatus for reserving functions of a device using a control point (CP) on universal plug and play (UPnP).

The present invention also provides a computer readable recording medium storing a program for executing the method.

According to an aspect of the present invention, there is provided a reservation method for a control point (CP) that discovers a device in a network and controls the device, the reservation method comprising: (a) discovering the device in the network; and (b) reserving the device to perform a specific command at a specific time.

According to another aspect of the present invention, there is provided a reservation apparatus for use in a CP that discovers a device in a network and controls the device, the reservation apparatus comprising: a discovery module which discovers the device in the network; and a control module which reserves the device to perform a specific command at a specific time.

According to another aspect of the present invention, there is provided a computer-readable storage medium having embodied thereon a computer program for executing a reservation method in a CP that discovers a device in a network and controls the device, the reservation method comprising: discovering the device in the network; and reserving the device to perform a specific command at a specific time.

According to another aspect of the present invention, there is provided a reservation processing method using a device that is discovered by a CP located in a network and controlled by the CP, the method comprising: (a) transmitting a message advertising the device to the CP; and (b) performing a specific command at a specific time according to a reservation of the CP that receives the message.

According to another aspect of the present invention, there is provided a reservation processing apparatus for use in a device that is discovered by a CP located in a network and controlled by the CP, the apparatus comprising: a discovery module transmitting a message advertising the device to the CP; and a control module performing a specific command at a specific time according to a reservation of the CP that receives the message from the discovery module.

According to another aspect of the present invention, there is provided a computer-readable storage medium having embodied thereon a computer program for executing a reservation processing method using a device that is discovered by a CP located in a network and controlled by the CP, the reservation processing method comprising: transmitting a message advertising the device to the CP; and performing a specific command at a specific time according to a reservation of the CP that receives the message.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a conventional universal plug and play (UPnP) network system;

FIG. 2 is a block diagram of an UPnP network system according to an exemplary embodiment of the present invention;

FIG. 3 is a block diagram of a device that can be reserved according to an exemplary embodiment of the present invention;

FIG. 4 illustrates a device description according to an exemplary embodiment of the present invention;

FIGS. 5A through 5C illustrate timer service descriptions according to an exemplary embodiment of the present invention;

FIG. 6 is a flowchart of a reservation method according to an exemplary embodiment of the present invention;

FIG. 7 is a flowchart of a reservation processing method according to an exemplary embodiment of the present invention; and

FIG. 8 is a flowchart of a method of reproducing a reserved TV program using a timer service according to an exemplary embodiment of the present invention.

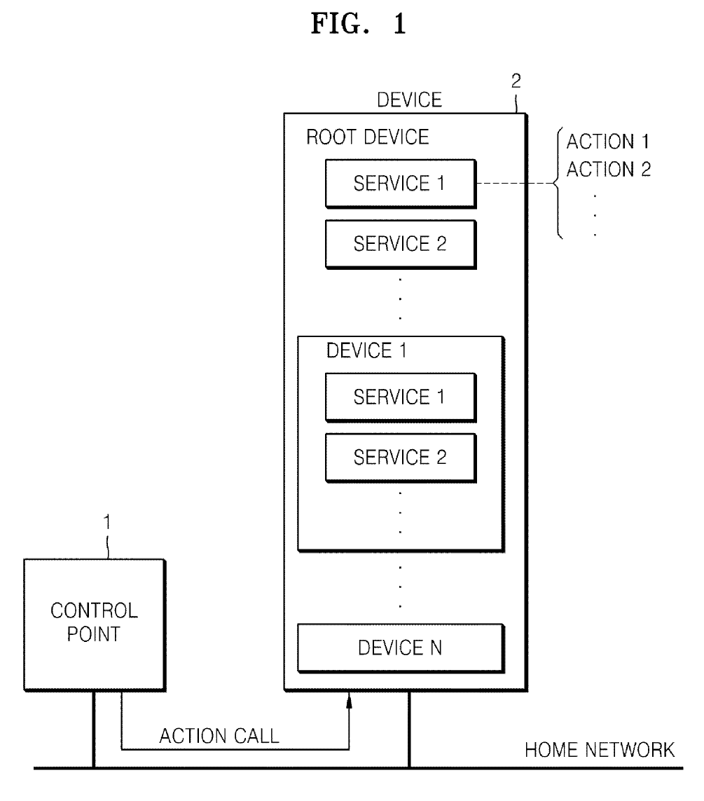

### DETAILED DESCRIPTION OF EXEMPLARY EMBODIMENTS OF THE INVENTION

The present invention will now be described more fully with reference to the accompanying drawings.

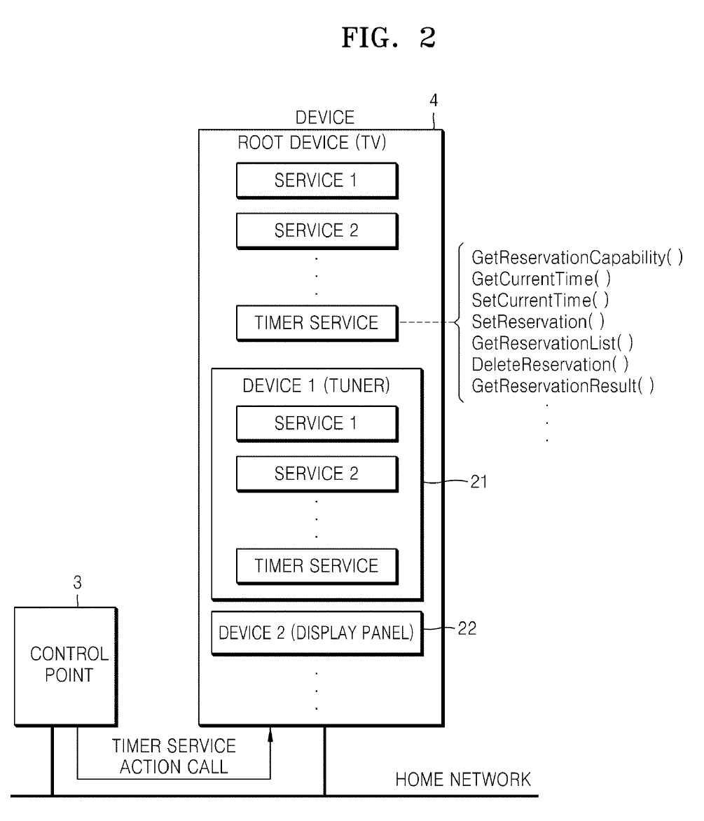

FIG. 2 is a block diagram of a universal plug and play (UPnP) network system according to an exemplary embodiment of the present invention. Referring to FIG. 2, the UPnP network system comprises a control point (CP) 3 and a device 4.

The CP 3 discovers the device 4 on a home network and controls the device 4 according to UPnP.

The device 4 provides a timer service which reserves a specific command to be performed at a specific time. Therefore, the CP 3 reserves the device 4 to perform the specific command based on the specification of the timer service. The timer service provides UPnP actions which are a kind of API function, e.g., “GetReservationCapability( )”, “GetCurrentTime( )”, “SetCurrentTime( )”, “SetReservation(futureTime, command, args, . . . )”, “GetReservationList( )”, “DeleteReservation(commandId, . . . )”, “GetReservationResult(commandId, . . . ), etc. That is, the CP 3 calls the UPnP actions to reserve the device 4 to perform the specific command at the specific time.

The device 4 can provide the timer service to each of a tuner 21 and a display panel 22 since the tuner 21 and the display panel 22, which are embedded devices of a root device, i.e., a television (TV), can independently manage power. In detail, the device 4 provides the timer service of the root device and the embedded device, thereby managing the total power of the device 4 and a partial power of the embedded devices 21 and 22.

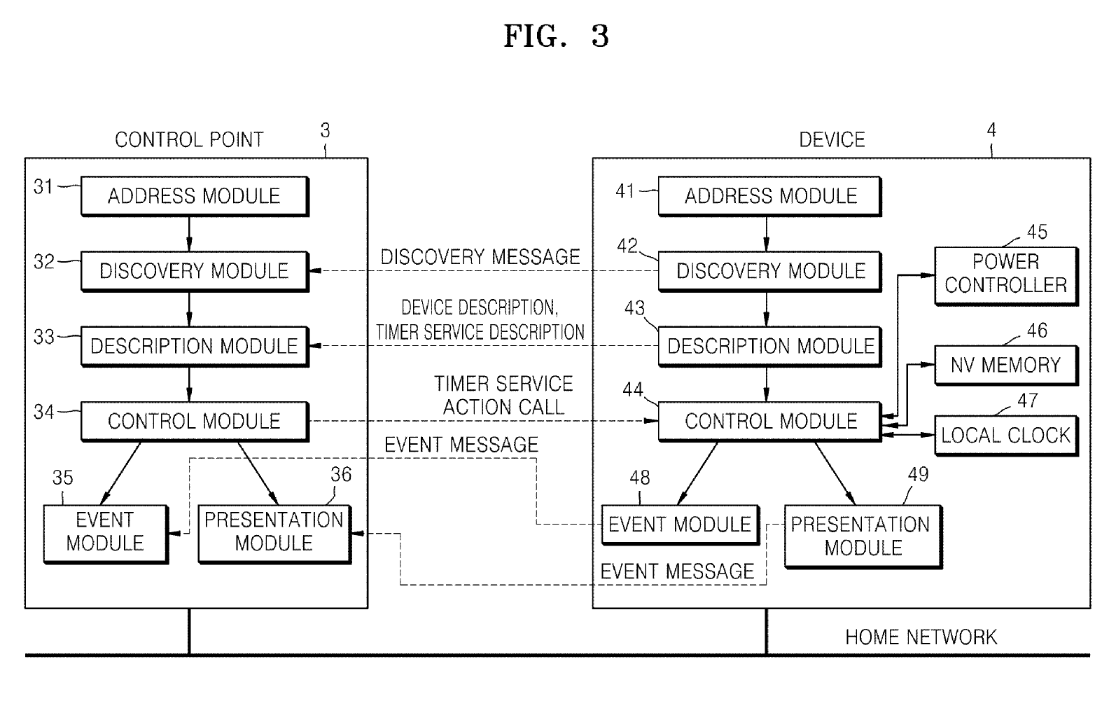

FIG. 3 is a block diagram of a reservation device according to an exemplary embodiment of the present invention. Referring to FIG. 3, the reservation device of the CP 3 comprises an address module 31, a discovery module 32, a description module 33, a control module 34, an event module 35, and a presentation module 36.

The address module 31 performs an UPnP addressing. That is, the address module 31 determines an IP address of the CP 3. More specifically, if there is a DHCP server (not shown) in a home network, an IP address is allocated to the address module 31 from the DHCP server, and the address module 31 determines the IP address as an IP address of the CP 3. If there is no DHCP server in the home network, the address module 31 obtains an IP address using an auto IP function of UPnP and determines the IP address as an IP address of the CP 3.

The discovery module 32 performs an UPnP discovery. That is, the discovery module 32 discovers the device 4 on the home network using the IP address of the CP 3 determined by the address module 31. If the device 4 is added to the home network, the discovery module 32 receives a discovery message from the device 4. If the CP 3 is added to the home network, the discovery module 32 transmits a message searching for devices on the home network, and receives the discovery message from the device 4, thereby discovering the device 4 on the home network.

The description module 33 performs an UPnP description. That is, the description module 33 obtains a description of the device 4 discovered by the discovery module 32. More specifically, the description module 33 obtains the description of the device 4 from a URL “URL for UPnP description for root device” of a device description included in the discovery message obtained from the device 4.

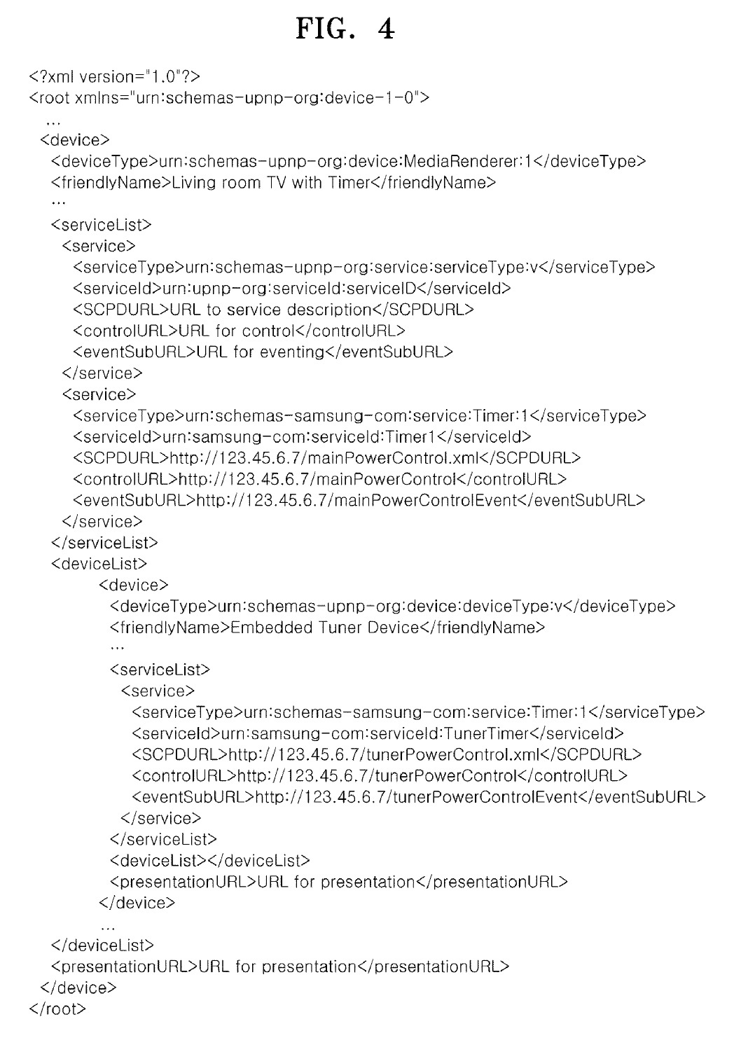

FIG. 4 illustrates a device description according to an exemplary embodiment of the present invention. Referring to FIG. 4, the device description is a description of the device 4 in the format of extensible markup language (XML). Syntax “<serviceType>urn:schemas-samsung-com:service:service:Timer:1</serviceType>” indicates that the device 4 provides the timer service.

Also, syntaxes “<serviceId>urn: samsung-com:serviceId:Timer1</serviceId>” and “<serviceId>urn: samsung-com:serviceId:TunerTimer</serviceId>” indicate that the TV that is the root device of the device 4 and the tuner 21 that is the embedded device of the device 4 provide separately the timer service.

The description module 33 obtains a description of the service provided by the device 4 from a URL “URL to service description” of the device description included in the description to the device 4. In particular, according to the current exemplary embodiment, the description module 33 obtains a description of the timer service from URL “<SCPDURL>http://123.45.6.7/mainPowerControl.xml</SCPDURL>” of the timer service description included in the description of the device 4.

Furthermore, the description module 33 obtains a description of the timer service provided by the embedded device 21 of the device 4 from a URL “<SCPDURL>http ://123.45.6.7/tunerPowerControl.xml</SCPDURL>” of a timer service description provided by the embedded device 21 of the device 4 and included in the description of the device 4.

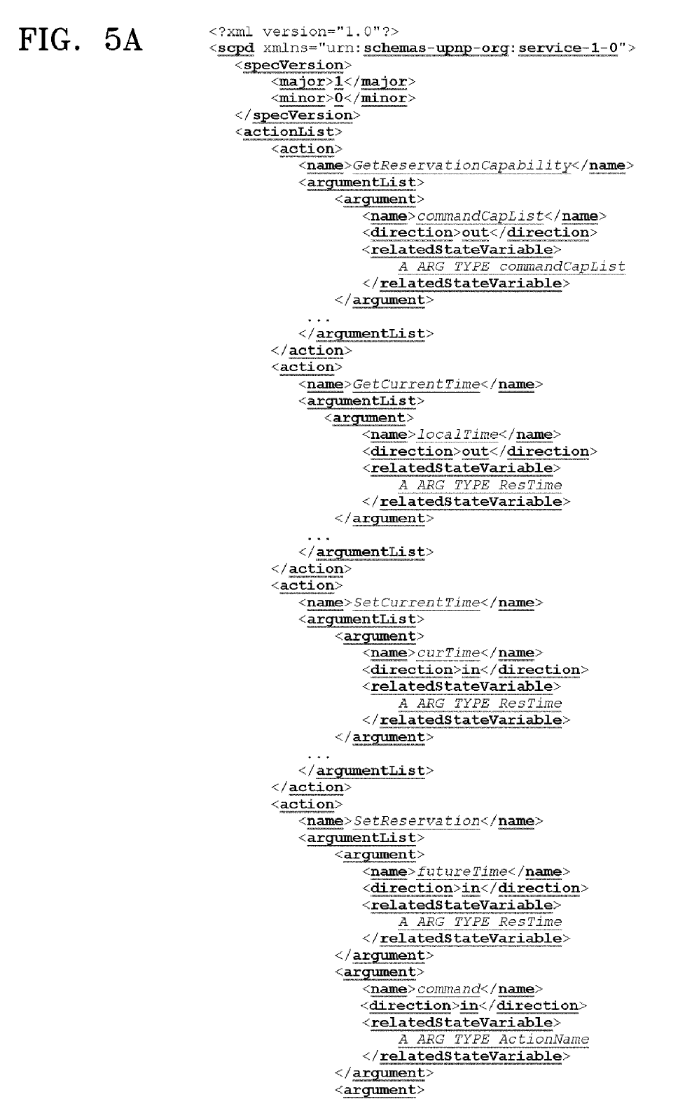

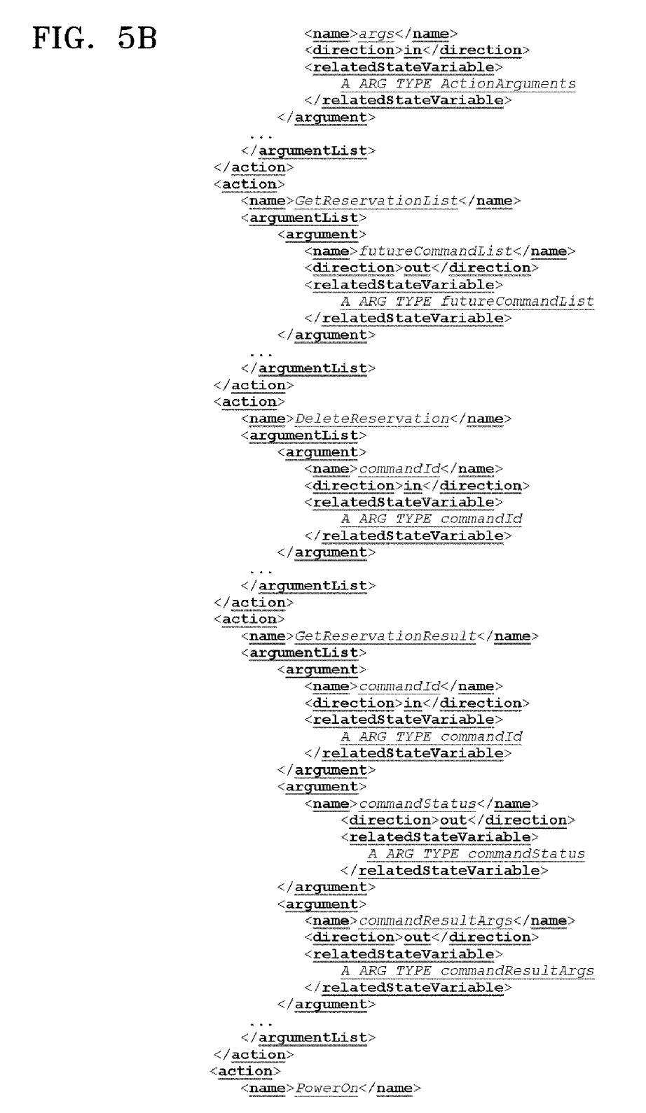

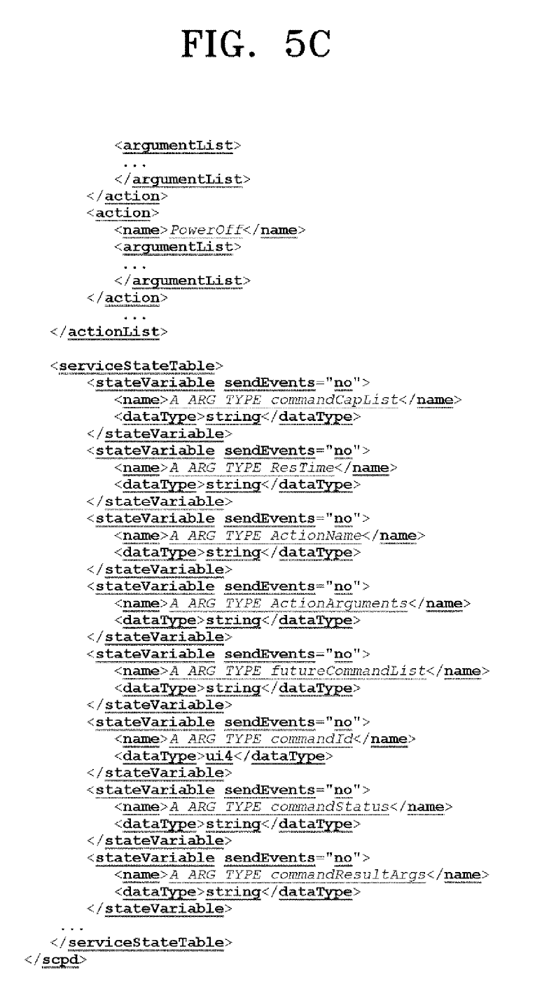

FIGS. 5A through 5C illustrate timer service descriptions according to an exemplary embodiment of the present invention. Referring to FIGS. 5A through 5C, the timer service descriptions are descriptions of the timer service provided by the device 4 in XML format. Each of the timer service descriptions includes a list of actions provided by the timer service and a list of arguments of each of the actions.

The control module 34 performs an UPnP control. That is, the control module 34 controls the device 4 based on the description of the device 4 obtained by the description module 33. More specifically, the control module 34 calls one of the actions included in the description of a service with regard to a “URL for control” included in the description of the device 4 in order to control the service, thereby controlling the device 4.

In particular, according to the current exemplary embodiment of the present invention, the control module 34 reserves the device 4 discovered by the discovery module 32 to perform a specific command at a specific time. More specifically, the control module 34 calls one of the actions included in the description of the timer service provided by the device 4 based on the timer service description obtained by the description module 33 to reserve the device 4 to perform a specific command at a specific time.

Furthermore, the control module 34 reserves the embedded device 21 of the device 4 discovered by the discovery module 32 to perform a specific command at a specific time. More specifically, the control module 34 calls one of the actions included in the description of the timer service provided by the embedded device 21 based on the timer service description provided by the embedded device 21 of the device 4 and obtained by the description module 33 to reserve the device 4 to perform a specific command at a specific time.

The timer service descriptions illustrated in FIGS. 5A through 5C will now be described in detail. The control module 34 calls “GetReservationCapability( )” among the actions included in the timer service descriptions to request the device 4 to provide a list of commands to be performed according to the reservation of the CP 3. The control module 34 obtains a list of the commands in response to the request. That is, the control module 34 obtains the list “commandCapList” of the commands as a return value of the called action. In particular, the commands can be newly defined in the current exemplary embodiment of the present invention or can be defined in an existing service such as a content directory service. For example, the commands are the “browse( )”, “search( )”, etc., of the content directory service.

The control module 34 calls “GetCurrentTime( )” among the actions included in the timer service description illustrated in FIGS. 5A through 5C to request the device 4 to provide a local time of the device 4. The control module 34 obtains the local time of the device 4 in response to the request. That is, the control module 34 obtains the local time of the device 4, “localTime”, as a return value of the called action. In particular, if “commandCapList” is not a list of commands but “*”, the “commandCapList” indicates that the device 4 reserves all the commands and performs the actions.

The control module 34 calls “SetCurrentTime(curTime, . . . )” among the actions included in the timer service description illustrated in FIGS. 5A through 5C to request the device 4 to set a current time included in the called action, “curTime”, as the local time of the device 4. In particular, when a user recognizing the “localTime” presented by the presentation module 36 does not select the “localTime” but the “curTime”, the control module 34 requests the device 4 to set the “curTime” selected by the user as the local time of the device 4. In general, the “curTime” is a current time of the control module 34. Thereafter, the control module 34 can confirm whether the local time of the device 4 is normally set in response to the request as a return value of the called action.

The control module 34 calls “SetReservation(futureTime, command, args, . . . )” among the actions included in the timer service description illustrated in FIGS. 5A through 5C to reserve the device 4 to perform a specific command “command” at a specific time “futureTime” included in the called action. In particular, when the user recognizing the “commandCapList” presented by the presentation module 36 selects one of the “commandCapList”, the control module 34 calls “SetReservation(futureTime, command, args, . . . )” including the command selected by the user as an “command” argument to reserve the device 4 to perform the command selected by the user.

The control module 34 can call “SetReservation(futureTime, command, args, . . . )” based on the “curTime” included in the called “SetCurrentTime(curTime, . . . )”. Thereafter, the control module 34 can confirm whether the called action is normally registered with the timer service of the device 4 from a return value to the called action. The “futureTime” can be presented as “year:month:day:time” or “a specific time after the current time”. Also, when the “futureTime” is 0, the selected command can be promptly performed.

For example, the control module 34 calls “SetReservation(2006:1:1:0:00, PowerOn, args, . . . )” to reserve the device 4 to be powered on at 0:00 hours on Jan. 1, 2006. The control module 34 calls “SetReservation(2006:1:1:1:00, PowerOff, args, . . . )” to reserve the device 4 to be powered off at 1:00 hours on Jan. 1, 2006.

The “SetReservation(2006:1:1:0:00, PowerOn, args, . . . )” and the “SetReservation(2006:1:1:1:00, PowerOff, args, . . . )” can be realized using separate actions PowerOn( )and PowerOff( ) which can be understood by those having ordinary skill in the art to which the current exemplary embodiment pertains.

The control module 34 calls “GetReservationList( )” among the actions included in the timer service description illustrated in FIGS. 5A through 5C to request the device 4 to provide a list of commands that can be reserved by the device 4. Thereafter, the control module 34 obtains “futureCommandList” the list of the commands that can be reserved by the device 4 in response to the request as a return value of the called action.

The control module 34 calls “DeleteReservation(commandId, . . . )” among the actions included in the timer service description illustrated in FIGS. 5A through 5C to request the device 4 to delete an action corresponding to “commandId” one of the commands that can be reserved by the device 4. In particular, when user recognizing the “futureCommandList” presented by the presentation module 36 selects one of the “futureCommandList”, the control module 34 calls “DeleteReservation(commandId, . . . )” including a command selected by the user as a “commandId” argument to request the device 4 to delete the command selected by the user. Thereafter, the control module 34 can confirm from a response to the request whether the command selected by the user is normally deleted from the list of the commands currently reserved by the device 4. That is, the control module 34 can confirm from a return value of the called action whether a command corresponding to “commandId” is normally deleted from the list of the commands currently reserved by the device 4.

The control module 34 calls “GetReservationResult(commandId, . . . )” among the actions included in the timer service description illustrated in FIGS. 5A through 5C to request the device 4 to provide a result obtained by performing the command corresponding to the “commandId”. The control module 34 obtains the result obtained by performing the command corresponding to the “commandId” from a response to the request. That is, the control module 34 can confirm from a return value of the called action whether the command corresponding to the “commandId” is normally performed.

The event module 35 performs an UPnP event. That is, the event module 35 receives an event message informing a change in the state of the device 4 from the device 4 controlled by the control module 34. In particular, according to the current exemplary embodiment of the present invention, a status parameter “PowerState” relating to the timer service is added to existing status parameters of the UPnP. The “PowerState” is a parameter indicating a current power state of the device 4. That is, when the current power state of the device 3 is changed, the event module 35 receives the event message indicating a change in power on/off status of the device 4.

The presentation module 36 performs an UPnP presentation. That is, the presentation module 36 presents the device 4 to the user based on the description of the device 4 obtained by the description module 33. More specifically, the presentation module 34 requests presentation page for the URL of presentation page, i.e. “URL for presentation”, and obtains a presentation page in response to the request. The presentation module 36 loads the presentation page to a browser (not shown) to present it to the user. The browser can be set in the CP 3, the device 4, or other device.

In particular, according to the current exemplary embodiment of the present invention, the presentation module 36 presents the “localTime” obtained by the control module 34 to the user. Also, the presentation module 36 presents the “commandCapList” obtained by the control module 36 to the user. The presentation module 36 presents the “futureCommandList” obtained by the control module 36 to the user.

Referring to FIG. 3, a reservation processing device of the device 4 comprises an address module 41, a discovery module 42, a description module 43, a control module 44, a local clock 47, a power controller 45, a non-volatile (NV) memory 46, an event module 48, and a presentation module 49.

The address module 41 performs an UPnP addressing. That is, the address module 41 determines an IP address of the device 4. More specifically, if a DHCP server (not shown) is connected to the home network, an IP address is allocated to the address module 41 from the DHCP server, and the address module 41 determines the IP address as an IP address of the device 4. If no DHCP server is connected to the home network, the address module 41 obtains an IP address using an auto IP of the UPnP and determines the IP address as an IP address of the device 4.

The discovery module 42 performs an UPnP discovery. That is, the CP 3 on the home network discovers the discovery module 42 using the IP address of the device 4 determined by the address module 41. If the device 4 is added to the home network, the discovery module 42 transmits a discovery message advertising the device 4 to the CP 3 to allow the CP 3 to discover the device 4 on the home network. If the CP 3 is added to the home network, the discovery module 42 receives a message to search for devices on the home network from the CP 3, and transmits the discovery message advertising the device 4 in response to the message to allow the CP 3 to discover the device 4 on the home network.

The description module 43 performs an UPnP description. That is, the description module 43 provides the description of the device 4 to the CP 3 that received the discovery message from the discovery module 42. More specifically, if the CP 3 accesses the URL “URL for UPnP description for root device” of the device description included in the discovery message, the description module 43 provides the description of the device 4 to the CP 3.

If the CP 3 accesses the URL “URL to service description” of the service description included in the description to the device 4 illustrated in FIG. 4, the description module 43 provides the description of the service provided by the device 4 to the CP 3. In particular, according to the current exemplary embodiment of the present invention, if the CP 3 accesses the URL “<SCPDURL>http ://123.45.6.7/mainPowerControl.xml</SCPDURL>” of the timer service description included in the description to the device 4, the description module 43 provides the description of the timer service to the CP 3.

Furthermore, if the CP 3 accesses the URL “URL to service description” of the timer service description provided by the embedded device 21 of the device 4 and included in the description to the device 4, the description module 43 provides the description to the timer service provided by the embedded device 21 of the device 4 to the CP 3. In particular, according to the current exemplary embodiment of the present invention, if the CP 3 accesses the URL “<SCPDURL>http://123.45.6.7/tunerPowerControl.xml<CPDURL>” of the timer service description included in the description to the device 4, the description module 43 provides the description of the timer service to the CP 3.

The control module 44 performs an UPnP control. That is, the CP 3 that obtained the description of the device 4 provided by the description module 43 controls the control module 44. More specifically, if the CP 3 accesses the URL “URL for control” included in the description of the device 4 and used to control a service and calls one of the actions included in the description of the service provided by the device 4, the control module 44 receives the called action and is controlled by the CP 3.

In particular, according to the current exemplary embodiment of the present invention, if the control module 44 receives the discovery message from the discovery module 42, receives a reservation in which the device 4 performs a specific command at a specific time from the CP 3 that obtained the description of the device 4 and the description of the timer service provided by the device 4, the device 4 performs the specific command at the specific time according to the reservation of the CP 3. Furthermore, if the control module 44 receives a reservation in which the embedded device 21 performs a specific command at a specific time from the CP 3 that obtained the description of the timer service provided by the embedded device 21 of the device 4, the embedded device 21 performs the specific command at the specific time.

More specifically, the control module 44 receives a call of an action of the timer service that reserves the specific command to be performed at the specific time from the CP 3, and registers the call of the action with the timer service of the control module 44. The control module 44 instructs the power controller 45 to set the specific time as a power-on time of the device 4, and stores the specific command in the NV memory 46. Thereafter, at the specific time, the device 4 is powered on according to the power on of the power controller 45, and the timer service of the control module 44 discovers the specific command from the NV memory 46 and performs the specific command. The control module 44 completes performing of the specific command, and instructs the power controller 45 to power off the device 4.

The power controller 45 sets the specific time as the power on time of the device 4 according to the instruction of the control module 44. The power controller 45 enables the device 4 to be powered on at the specific time. The power controller 45 enables the device to be powered off according to the instruction of the control module 44.

When the control module 44 receives the call of the action of the timer service that reserves the specific command to be performed at the specific time from the CP 3, the NV memory 46, that is a non-volatile memory, stores the specific command. Therefore, although the device 4 is powered off, the specific command remains in the NV memory 46.

Referring to the timer service description illustrated in FIGS. 5A through 5C, the timer service of the control module 44 receives a call “GetReservationCapability( )” among the actions included in the timer service description, and provides the list “commandCapList” of the commands performed by the device 4 according to the reservation of the CP 3.

The timer service of the control module 44 receives a call “GetCurrentTime( )” among the actions included in the timer service description, and provides “localTime,” i.e., the local time of the device 4, which is a clock value of the local clock 47. In particular, when the device 4 reserves all the commands and performs the commands, the timer service of the control module 44 does not write a list of commands but inserts “*” in the “commandCapList”.

The control module 44 receives a call “SetCurrentTime(curTime, . . . )” among the actions included in the timer service description illustrated in FIGS. 5A through 5C and instructs the local clock 47 to set “curTime,” i.e., a current time included in the call of the action, as the local time of the device 4. The control module 44 can inform that the local time of the device 4 is normally set as a return value of the call of the action.

The local clock 47 cannot be synchronized with the local clock of the CP 3 as a real time clock of the device 4. Therefore, the local clock 47 provides a clock value to the control module 44, and sets the local time of the device 4 as the “curTime” included in the call of “SetCurrentTime(curTime, . . . )” according to the instruction of the control module 44.

The control module 44 receives a call “SetReservation(futureTime, command, args, . . . )” among the actions included in the timer service description illustrated in FIGS. 5A through 5C, and performs a specific command “command” at a specific time “futureTime” included in the call the action. In particular, the control module 44 performs a command selected by the user from the “commandCapList” provided by receiving the call of “GetReservationCapability( )”. Also, the control module 44 performs the specific command at the specific time based on the local time of the device 4 set by receiving the call of “SetCurrentTime(curTime, . . . )”. The control module 44 can inform that the call of the action is normally registered with the timer service of the control module 44 as a return value of the call of the action.

For example, the control module 44 receives a call “SetReservation(2006:1:1:0:00, PowerOn, args, . . . )”, and performs the power on of the device 4 at 0 on 1 January, 2006. The control module 44 can inform that the power one of the device 4 is normally performed at 0:00 hours on Jan. 1, 2006 as a return value of the call of the action. The control module 44 receives a call “SetReservation(2006:1:1:1:00, PowerOff, args, . . . )”, and performs the power off of the device 4 at 1: :00 hours on Jan. 1, 2006.Thereafter, the control module 44 can inform that the power off of the device 4 is normally performed at 1:00 hours on Jan. 1, 2006, as a return value of the call of the action.

The control module 44 receives a call “GetReservationList( )” among the actions included in the timer service description illustrated in FIGS. 5A through 5C, and provides the list “futureCommandList” of the commands that are reserved to be performed by the device 4.

The control module 44 receives a call “DeleteReservation(commandId, . . . )” among the actions included in the timer service description illustrated in FIGS. 5A through 5C, and deletes a command corresponding to the “commandId” which is one of the commands that are reserved to be performed by the device 4. The control module 44 can inform that the command corresponding to the “commandId” is normally deleted from the list of the commands that are reserved to be performed by the device 4 as a return value of the call of the action.

The control module 44 receives a call “GetReservationResult(commandId, . . . )” among the actions included in the timer service description illustrated in FIGS. 5A through 5C, and can inform the CP 3 that the command corresponding to the “commandId” is normally performed as a return value of the call of the action.

The event module 48 performs an UPnP event. That is, the event module 48 transmits an event message informing a change in the state of the device 4 controlled by the CP 3. In particular, according to the current exemplary embodiment of the present invention, when a current power state of the device 4 is changed, the event module 48 transmits the event message informing a change in the power on/off status of the device 4 to the CP 3.

The presentation module 46 performs an UPnP presentation. That is, the presentation module 46 provides information for presenting the device 4 to the CP 3. More specifically, if the CP 3 accesses the URL “URL for presentation” of a presentation page, the presentation module 46 provides the presentation page to the CP 3.

In particular, according to the current exemplary embodiment of the present invention, the presentation module 46 provides a page presenting the “localTime” to the CP 3. The presentation module 46 provides a page presenting the “commandCapList” to the CP 3. The presentation module 46 provides a page presenting the “futureCommandList” to the CP 3.

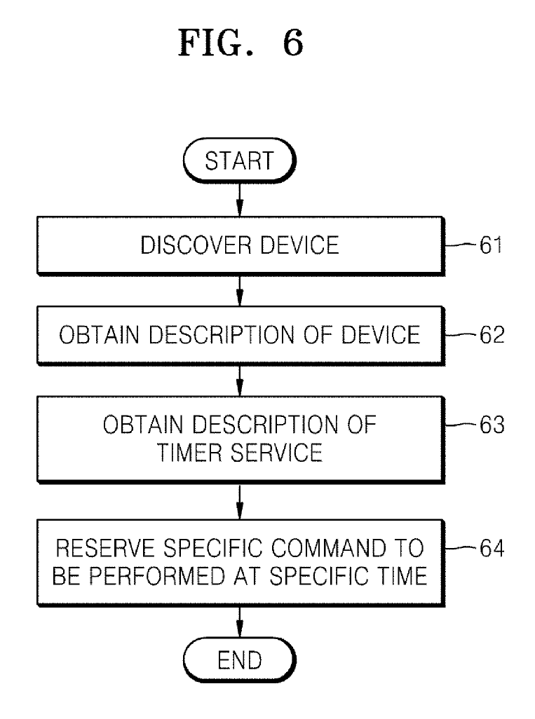

FIG. 6 is a flowchart of a reservation method according to an exemplary embodiment of the present invention. Referring to FIG. 6, the reservation method is performed in time series by the CP 3 illustrated in FIG. 3. Therefore, although not described, the description relating to the CP 3 illustrated in FIG. 3 is applied to the reservation method of the current exemplary embodiment of the present invention.

The CP 3 receives a discovery message from the device 4 to discover it on a home network (Operation 61).

The CP 3 obtains a description of the device 4 from the device 4 (Operation 62).

The CP 3 obtains a description of a timer service provided by the device 4 from a URL of a timer service description included in the description of the device 4 (Operation 63).

The CP 3 calls one of the actions included in the description of the timer service provided by the device 4 based on the timer service description to reserve the device 4 to perform a specific command at a specific time (Operation 64).

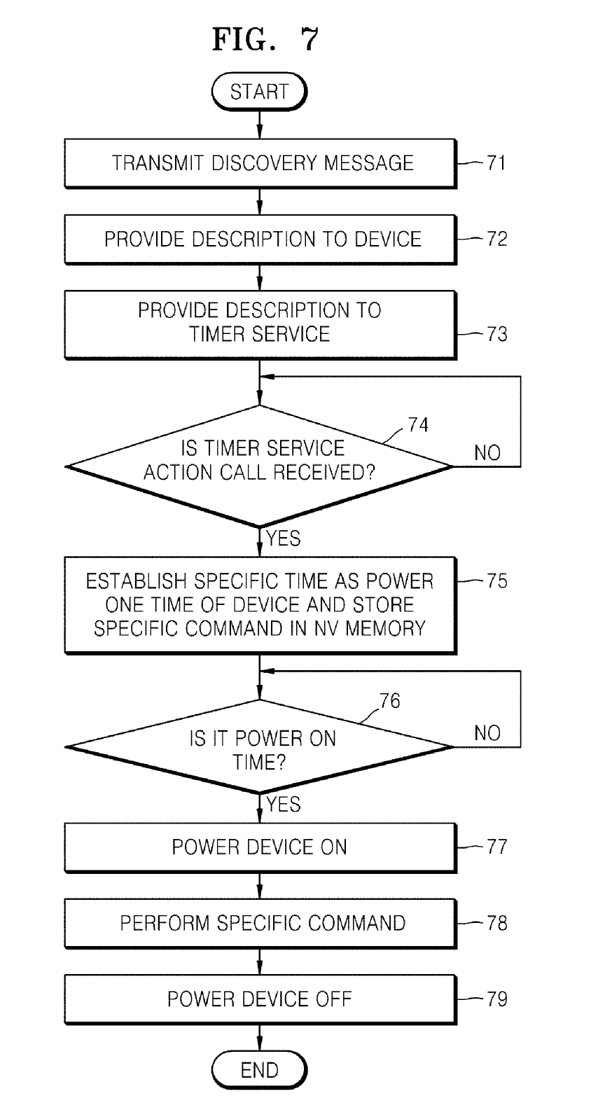

FIG. 7 is a flowchart of a reservation processing method according to an exemplary embodiment of the present invention. Referring to FIG. 7, the reservation processing method is performed in time series by the device 4 illustrated in FIG. 3. Therefore, although not described, the description relating to the device 4 illustrated in FIG. 3 is applied to the reservation processing method of the current exemplary embodiment of the present invention.

The device 4 transmits a discovery message 4 to the CP 3 to enable the CP 3 to discover it in a home network (Operation 71).

The device 4 provides its description to the CP 3 that received the discovery message (Operation 72).

If the CP 3 that obtained the description of the device 4 accesses a URL of a timer service description included in the description to the device 4, the device 4 provides its description to a timer service provided by the device 4 to the CP 3 (Operation 73).

If the device 4 receives a call of an action of the timer service that reserves a specific command to be performed at a specific time from the CP 3 that obtained the description of the timer service (Operation 74), the device 4 performs Operation 75. If not, the device 4 enters a stand by mode.

The device 4 sets the specific time included in the call of the action as a power on time of the device 4 and stores the specific command in the NV memory 46 (Operation 75).

When a local time of the device 4 is the same with the power on time of the device 4 (Operation 76), the device 4 performs Operation 77. If not, the device 4 enters a stand by mode.

The device 4 is powered on (Operation 77).

The device 4 discovers the specific command from the NV memory 46 and performs the specific command (Operation 78).

The device 4 completes performing the specific command and is powered off (Operation 79).

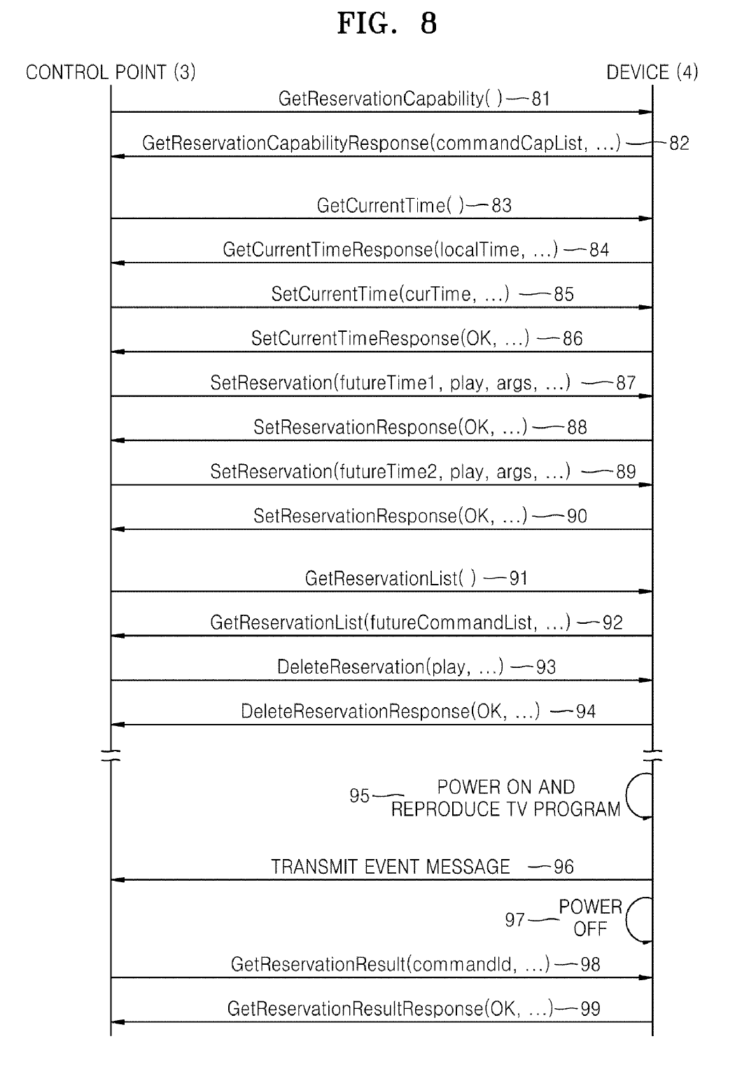

FIG. 8 is a flowchart of a method of reproducing a reserved TV program using a timer service according to an exemplary embodiment of the present invention. Referring to FIG. 8, the CP 3 calls “GetReservationCapability( )” and the device 4 receives the call of the action (Operation 81).

The device 4 provides a list “commandCapList” of commands to be performed by the device 4 according to a reservation of the CP 3 (Operation 82). Therefore, a user can see the list of the commands to be performed by the device 4 according to the reservation of the CP 3.

The CP 3 calls “GetCurrentTime( )” and the device 4 receives the call of the action (Operation 83).

The device 4 provides a local time “localTime” of the device 4, which is a clock value of the local clock 47 (Operation 84).

The CP 3 calls “SetCurrentTime(curTime, . . . )” and the device receives the call of the action (Operation 85).

The device 4 establishes a current time “curTime” included in the call of the action as its local time and notifies the CP 3 that its local time is normally established (Operation 86). Therefore, a local clock of the CP 3 is synchronized with that of the device 4.

The CP 3 calls “SetReservation(2006:1:1:7:00, play, args, . . . )” and the device 4 receives the call of the action (Operation 87).

The device 4 registers the call of the action with its timer service and notifies that the call of the action is normally registered with its timer service (Operation 88).

The CP 3 calls “SetReservation(2006:1:2:7:00, play, args, . . . )” and the device 4 receives the call of the action (Operation 89).

The device 4 registers the call of the action with its timer service and notifies that the call of the action is normally registered with its timer service (Operation 90).

The CP 3 calls “GetReservationList( )” and the device 4 receives the call of the action (Operation 91).

The device 4 provides a list “futureCommandList” of commands reserved to be performed by the device 4 (Operation 92). Therefore, the user can see the list of the commands reserved to be performed by the device 4, “play1”, and “play2”. The “play1” is an ID of the command reserved by calling “SetReservation(2006:1:1:7:00, play, args, . . . )”, and the “play2” is an ID of the command reserved by calling “SetReservation(2006:1:2:7:00, play, args, . . . )”.

The CP 3 calls “DeleteReservation(play1, . . . )”, and the device 4 receives the call of the action (Operation 93).

The device 4 deletes a command corresponding to the “play1”, which is one of the commands to be performed according to the reservation of the CP 3 (Operation 94). The device 4 may also notify that it normally deletes the command corresponding to the “play1” from the list of the commands that it reserved as a return value of the call of the action (Operation 94).

The device 4 is powered on at 7:00 on Jan. 2, 2006, and reproduces the TV program (Operation 95).

The device 4 transmits an event message indicating that it is powered on to the CP 3 (Operation 96).

The device 4 is powered off after the TV program is completely reproduced (Operation 97).

The CP 3 calls “GetReservationResult(play2, . . . )” and receives the call of the action (Operation 98).

The device 4 notifies that the command corresponding to the “play2” is normally performed as a return value of the call of the action (Operation 99).

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves.

According to the present invention, a CP calls an action that reserves a specific command to be performed at a specific time and a device receives the call of the action so that the specific command can be performed at the specific time, thereby reserving functions of the UPnP device. Such a reservation can be used to power on/off home appliances such as TVs, audios, washing machines, etc., at a future time and to reserve a specific function of the home appliances to be performed at the future time.

Further, the present invention provides a timer service of a device and timer services of each of the embedded devices of the device, thereby managing the total power of the device and partial power of the embedded devices of the device.

While the present invention has been particularly shown and described with reference to exemplary embodiments thereof, it will be understood by those skilled in the art that various changes in form and details may be made therein without departing from the spirit and scope of the invention as defined by the appended claims.

1. A reservation method for a control point (CP) that discovers a device in a network and controls the device, the reservation method comprising:
(a) discovering the device in the network; and
(b) reserving the device to perform a specific command at a specific time.

2. The reservation method of claim 1, wherein in operation (b), an action that reserves the specific command to be performed at the specific time is called.

3. The reservation method of claim 1, further comprising:
obtaining a description of a service provided by the device,
wherein in operation (b), the specific command is reserved to be performed at the specific time based on the description of the service provided by the device.

4. The reservation method of claim 1, further comprising:
obtaining a description of a service provided by an embedded device of the device,
wherein in operation (b), the embedded device is reserved to perform the specific command at the specific time based on the description of the service provided by the embedded device.

5. The reservation method of claim 1, further comprising:
requesting the device to provide a list of at least one command to be performed by the device according to a reservation of the CP; and
obtaining the list from a response to the request,
wherein in operation (b), the device is reserved to perform one of the commands included in the list.

6. The reservation method of claim 1, further comprising:
requesting the device to provide a local time of the device;
obtaining the local time of the device from a response to the request; and
requesting the device to establish the local time of the device as another time different than the local time,
wherein in operation (b), the device is reserved to perform the specific command at the specific time based on the another time.

7. The reservation method of claim 1, further comprising:
requesting the device to provide a list of at least one command reserved to be performed by the device;
obtaining the list from a response to the request; and
requesting the device to delete one of the commands included in the list.

8. A reservation apparatus for use in a control point (CP) that discovers a device in a network and controls the device, the reservation apparatus comprising:
a discovery module which discovers the device in the network; and
a control module which reserves the device to perform a specific command at a specific time.

9. A computer-readable storage medium having embodied thereon a computer program for executing a reservation method in a control point (CP) that discovers a device in a network and controls the device, the reservation method comprising:
discovering the device in the network; and
reserving the device to perform a specific command at a specific time.

10. A reservation processing method using a device that is discovered by a CP located in a network and controlled by the control point (CP), the method comprising:
(a) transmitting a message advertising the device to the CP; and
(b) performing a specific command at a specific time according to a reservation of the CP that receives the message.

11. The method of claim 10, further comprising:
if a call of an action that reserves the specific command to be performed at the specific time is received, powering on the device at the specific time,
wherein in operation (b), the specific command is performed when the device is powered on.

12. The method of claim 10, further comprising:
providing a description of a service provided by the device to the CP that received receives the message,
wherein in operation (b), the specific command is performed at the specific time according to the reservation of the CP that obtains a description of a service provided by the device.

13. The method of claim 10, further comprising:
providing a description of a service provided by embedded devices of the device to the CP,
wherein in operation (b), the specific command is performed at the specific time using the embedded devices according to the reservation of the CP that obtains the description of the service provided by the embedded devices.

14. The method of claim 10, further comprising:
providing a list of at least one command to be performed by the device according to the reservation of the CP at the request of the CP,
wherein in operation (b), one of the commands included in the list is performed according to the reservation of the CP.

15. The method of claim 10, further comprising:
providing a local time of the device at the request of the CP; and
establishing the local time of the device as another time different than the local time at the request of the CP that obtains the local time of the device,
wherein in operation (b), the specific command is performed at the specific time based on the local time.

16. The method of claim 15, further comprising:
providing a list of at least one command reserved to be performed by the device at the request of the CP; and
deleting one of the commands included in the list at the request of the CP that obtains the list.

17. A reservation processing apparatus for use in a device that is discovered by a control point (CP) located in a network and controlled by the CP, the apparatus comprising:
a discovery module transmitting a message advertising the device to the CP; and
a control module performing a specific command at a specific time according to a reservation of the CP that receives the message from the discovery module.

18. A computer-readable storage medium having embodied thereon a computer program for executing a reservation processing method using a device that is discovered by a control point (CP) located in a network and controlled by the CP, the reservation processing method comprising:
transmitting a message advertising the device to the CP; and
performing a specific command at a specific time according to a reservation of the CP that receives the message.
